(19) United States
(12) Patent Application Publication
(10) Pub. No.: US 2005/0087933 A1
(43) Pub. Date: Apr. 28, 2005

(54) Seal for use between two mobile parts of a hydraulic machine

(76) Inventor: Philipp Gittler, Wien (AT)

Correspondence Address: GREENBLUM & BERNSTEIN, P.L.C., 1950 ROLAND CLARKE PLACE, RESTON, VA, 20191, US

(21) Appl. No.: 10/973,266

(22) Filed: Oct. 27, 2004

(30) Foreign Application Priority Data
Jul. 31, 2002 (AT) A 1167/2002

(51) Int. Cl. F16J 15/34

(52) U.S. Cl. 277/387

(57) ABSTRACT

Arrangement for sealing a gap between first and second parts of a hydraulic machine. The arrangement includes at least one sealing element mounted with respect to the first and second parts. A first hydrostatic bearing is formed between a first surface of the at least one sealing element and the first part. A second hydrostatic bearing is formed between a second surface of the at least one sealing element and the second part. At least one first bearing element is arranged on at least one of the surface of the first part and the first surface. At least one second bearing element is arranged on at least one of the surface of the first part and the first surface. At least one supply line is structured and arranged to supply a hydraulic bearing medium. The hydraulic bearing medium is fed via the at least one supply line to the at least one first bearing element, and thereafter is fed via hydraulic resistance to the at least one second bearing element. This Abstract is not intended to define the invention disclosed in the specification, nor intended to limit the scope of the invention in any way.

### CROSS-REFERENCE TO RELATED APPLICATIONS

The instant application is a continuation-in-part of International Application No. PCT/EP2003/007039 filed on Jul. 2, 2003 and published as International Publication WO 2004/018870 on Mar. 4, 2004, the disclosure of which is hereby expressly incorporated by reference hereto in its entirety. The instant application also claims priority under 35 U.S.C. §119 of Austrian Application No. A 1167/2002 filed on Jul. 31, 2002.

### BACKGROUND OF THE INVENTION

1. Field of the Invention

The present invention relates to an apparatus for sealing a gap between two mutually mobile parts of a hydraulic machine with at least one sealing element which is mounted with respect to the two mobile parts by way of a hydrostatic bearing in each case. Each of the hydrostatic bearings comprises mutually facing bearing surfaces. At least one bearing surface has at least one bearing element, such as a groove, flute or the like, which can be supplied with a hydraulic bearing medium via at least one supply line. Furthermore, the invention discloses a method of operating the apparatus, a method of suing the seal, and a method of making such a seal.

2. Description of the Prior Art

On account of the very unfavorable operating conditions in the region of the external diameter of an impeller of a hydraulic machine and here, above all, in the case of relatively large machines with impeller diameters of up to some meters, it has previously not been possible to build a reliable seal between impeller and housing, which, in addition to a cost in terms of efficiency as a result of gap losses, can also lead to further considerable problems. This resides above all in the fact that, in the region of the external diameter of the impeller, very high circumferential speeds occur, the impeller and the housing are subjected to severe vibrations and, because of the high pressures that act, the impeller additionally experiences axial displacements. These operating states have previously prevented the building of a virtual or, ideally, completely tight seal. Seals which have previously been used, such as labyrinth seals, are not seals in the actual sense but merely devices for reducing the gap water flow. Other seals, such as known ice ring seals, were in turn very complicated and unreliable.

In the axial impeller lateral space, that is to say between the inner cover disk and housing, as a result of the gap water flow an occasionally very high pressure builds up, which corresponds substantially to the headwater pressure and which causes the impeller to displace in the axial direction, as a result of which excessively high axial loadings of the mounting and relatively high axial displacements of the impeller occur. In both impeller lateral spaces which are produced, between the housing and the outer and inner cover disk, a gap water flow is produced, as a result of which a certain proportion of the medium does not flow through the impeller and thus costs in terms of efficiency and a loss of performance occur. Furthermore, in both impeller lateral spaces there is produced a disk of water which rotates very quickly and, because of the friction which is produced, counteracts the rotation of the shaft and thus develops a braking effect which, in turn, further reduces the efficiency.

For these reasons, it is desirable to provide a virtually completely tight seal between impeller and housing.

Such a seal is known, for example from WO 02/23038 A1, in which substantially two types of seals, which comprise sealing rings specifically floatingly mounted on two hydrostatic bearings, are disclosed.

A first type, in which the sealing ring is mounted with respect to the housing and the impeller such that it cannot rotate, and a hydrostatic bearing is supplied with the bearing medium through flexible lines which lead from the turbine housing to the sealing ring. On account of the prevailing, previously described operating states, such flexible lines naturally represent a certain weak point, and therefore must be constructed accordingly ruggedly and the maintenance times must be shortened appropriately in order, by means of regular maintenance, to prevent a fracture arising from wear of the flexible lines, which can lead to a failure of the seal and to considerable damage. Furthermore, the installation of such a ring with a number of flexible lines is relatively complicated. For these reasons, such a design of a seal is rejected both by the manufacturers and by the operators.

The second type relates to sealing rings which, with respect to the impeller and the housing, are mounted in a “floating” and freely rotating manner, the bearing medium for the hydrostatic bearings being supplied through bores in the turbine housing and through connecting bores in the sealing ring itself. WO 02/23038 then specifically shows two variants of such a sealing ring.

In the first variant (according to FIG. 3 of WO 02/23038), a series of supply lines is provided, the openings of these supply lines into the bearing surfaces being opposite the openings of the connecting bores in the sealing ring. In practice, this ring exhibits unsatisfactory serviceability. This is because, if the sealing ring bears on the housing radially and in a fixed manner, then it is difficult to cause the sealing ring to lift in the radial direction, which means that all of the bearing medium which is forced in via the supply line is led via the connecting bore to the second bearing and leads to severe lifting in the axial direction. The sealing ring would therefore rub on the housing, which leads to damage and, as a consequence, can lead to destruction. On the other hand, in the case in which the ring is installed with a certain radial play, although it would be centered during operation and would be lifted radially and axially, because of the lack of a force balance, it would not assume a preferred position, it would be unstable and it would likewise be less capable of regulation radially. This is because, if an attempt is made to change the radial position by changing the volume flow, only the axial position would change, since a changed volume flow would in turn be passed on directly to the axial bearing via the connecting bore. Such a sealing ring would therefore be less practical in practice.

In the second variant (according to FIGS. 4 and 5 of WO 02/23038), at least two rows of supply lines are now provided, which are arranged at a distance from one another and via which, independently of one another, bearing medium is delivered into the hydrostatic bearings. The opening of only one of these two supply lines in this case is opposite the openings of the connecting bore in the sealing ring.

In the case of this variant, the advantage of this ring, that both the radial and the axial bearing can largely be driven and regulated separately and a stable operating position can be reached, is opposed by the disadvantage that, for the purpose of stabilizing and the ability to control both bearings, two rows of supply lines are needed, which have to be supplied and driven independently of one another, that is to say at least two sets of supply pumps, to some extent of considerable power, including the associated control or additional hydraulic components, such as restrictors, filters, etc., are required, so that the gain in performance through an effective seal is eaten up again, to some extent or even completely, by the required pump performance or by throttling losses. In addition, the production of such a seal is considerably more complicated in fabrication terms, since, of course, twice the number of bores and lines are needed.

### SUMMARY OF THE INVENTION

The present invention has aims to eliminate the disadvantages listed above and provides an effective and reliable seal of the type mentioned at the beginning which needs few resources, can be implemented and operated simply and has a long service life.

The invention provides that, at a distance from a first bearing element of a first hydrostatic bearing, at least one further, second bearing element of the first hydrostatic bearing is arranged, which is connected to the first bearing element via a hydraulic resistance. The supply line for this bearing opens only into the bearing surface in the region of the first bearing element.

Such a sealing element reduces the requisite number of supply lines and therefore reduces the expenditure on fabrication and also the number of supply units and elements required.

Although only a single supply line is provided, it is possible to set such a sealing element to a desired axial and radial bearing gap in a stable manner with the aid of a hydraulic resistance, which results in a stable operating position. Both bearing gaps can be varied by the volume flow and in this case are in a substantially fixed relationship with each other, that is to say the sealing element can be controlled completely in both directions with only one supply line. Since the sealing element is lifted substantially simultaneously and uniformly in the axial and in the radial direction, it is ensured that the sealing element is not lifted in only one direction, which increases the operational reliability considerably.

For the method of operating a seal according to the invention, the hydraulic machine is switched on only after the predefined bearing gaps have been set. As a result, frictional or mixed friction states and associated wear, damage or even destruction of the sealing element as the machine is run up are effectively prevented. The service life of such a sealing element is therefore improved considerably.

However, during the commissioning of the seal, that is to say during one of the first switch-on operations, it may be advantageous to bring the sealing element into a mixed friction state in a controlled manner, so that a bearing pattern can be ground into the bearing surfaces of the hydraulic bearings. Certain fabrication tolerances of the sealing element or of the bearing surfaces are therefore compensated for and the operation and the service life of the seal can be improved. After the bearing pattern has been ground in, the sealing element is, of course, raised to the predefined bearing gaps and operated normally.

Since the sealing element is typically fabricated from a softer material than the associated bearing surfaces on the housing or impeller or vice versa, such a bearing pattern can be achieved very simply and in a controlled manner.

The sealing element can be produced and operated very simply if the two hydraulic bearings are connected to each other by means of a hydraulic connection. It is therefore sufficient to supply only a single hydrostatic bearing with a bearing medium, as a result of which the second is automatically also supplied.

A very advantageous pressure distribution, which leads to secure lifting of the sealing element in both directions, is established by the width of the bearing element of the first hydrostatic bearing. The lifting can be based on the total width of this bearing. The width of the first hydrostatic bearing can be chosen to be smaller than the width of the bearing element of the second hydrostatic bearing, as based on the total width of this bearing. For the reliable operation of the sealing element and the achievement of sufficient stability, it is particularly advantageous if the distance between the two bearing elements of the hydrostatic bearing into which the supply line opens is smaller than a maximum distance which in this case results substantially from the geometric dimensions of the sealing element. By complying with this geometric predefinition, an extremely effective and operationally reliable sealing element is obtained.

A particularly simple sealing element results in the form of a sealing ring. Such a ring can be produced very simply and beneficially.

The service life of the sealing element is increased considerably if the sealing element is mounted in a floating manner on the hydrostatic bearings, since then solid body friction between sealing surface and sealing element is ruled out at all the operating points of the hydraulic machine.

The seal according to the invention is advantageously used for sealing an impeller and a housing of the hydraulic machine, in particular, of a turbo machine, with which the impeller lateral spaces can be sealed off effectively and, given an appropriate arrangement, for example, in the peripheral region of the impeller. The bearing medium is not filled with the operating medium of the hydraulic machine. The production of the aforementioned negative effects is prevented as a result.

The use of the seal for a turbine, in particular, a Francis turbine or pump turbine, or a pump, is quite particularly advantageous.

The bearing element can be formed simply and economically as an annular groove which may be interrupted in sections over the circumference, which, furthermore, can be produced very easily. Likewise simple in design and fabrication terms are bores as a hydraulic connection in the sealing element and as a supply line in the housing of the hydraulic machine.

The properties of the sealing element and therefore of the seal itself can be improved further by arranging a third bearing element, or a plurality of bearing elements, in the bearing surfaces of the hydrostatic bearing. The additional bearing element produces a broader pressure distribution, which can be managed better and with which the torque equilibrium on the sealing element can be set more easily.

The sealing element is advantageously designed in such a way that the central bearing element is designed to be wider than the other bearing elements. A further beneficial geometric predefinition results from the specific selection of the distance between the outer edges of the two outer of the plurality of bearing elements, as based on the width of this hydrostatic bearing, such that this distance is smaller than the width of the bearing element of the other hydrostatic bearing, as based on the width of this hydrostatic bearing. It is likewise beneficial, given predefined geometric dimensions of the sealing element, such as the height and width of the sealing ring, arrangement and width of the bearing elements, in particular of the grooves, flutes, etc., to select the distance between the first and the second bearing element of the first hydrostatic bearing to be smaller than a predetermined maximum distance.

The hydrostatic bearings are very advantageously supplied with a constant volume flow of the bearing medium. The sealing element is therefore able to react automatically and in a controllable manner to changes in the external conditions, such as temperature changes of the medium and an associated length change of the sealing element, vibrations of the housing or of the impeller, fabrication tolerances, tilting of the sealing ring, etc., since the volume flow, in addition to the geometric dimensions, is substantially responsible for the pressure distribution. The sealing element is therefore self-regulating, that is to say compensates automatically for external interference.

A simple supply of the hydrostatic bearings can be ensured by at least one pump. As a possible alternative to pumps, the headwater, which naturally has a high hydrostatic pressure, could also be used; at least one restrictor, which for example is designed as a flow regulating valve, should then be provided upstream of the opening of the supply line, in order to be able to predefine a specific, substantially constant volume flow.

The sealing element or the seal can be operated extremely advantageously and with low losses if the power loss caused by the sealing ring is minimized by way of a suitable geometry of the sealing element. Such a seal thus has a minimum power loss, as a result of which the overall efficiency of the turbine can be increased considerably, on account of preventing the formation of gap water flows through the seal.

The bearing action of the hydrostatic bearings can to some extent be increased considerably if, in at least one of the bearing surfaces, at least one hydrodynamic bearing element, such as a lubrication pocket, is additionally provided. Added to the conventional hydrostatic bearing action there is thus additionally a hydrodynamic bearing action which, at the speeds prevailing, can make up a considerable proportion of the overall bearing action.

In the event of failure of the volume flow supplying the hydraulic bearings, the hydraulic machine should preferably be switched off in order to prevent possible damage to the seal or to the sealing element. The operational reliability is increased if, in the event of a failure, an emergency supply of the hydraulic bearings is ensured, for example by way of an air reservoir, at least for a certain time period, preferably until the hydraulic machine has come to a standstill. By way of such an emergency supply, possible damage to the sealing ring can be avoided.

The efficiency can be improved still further by a number of the supply sources being switched off after the hydraulic machine has been run up. In this case, it should of course be ensured that the remaining supply is sufficient to keep the sealing element in the floating state in all operating states, without mixed friction phases occurring.

Substantially constant bearing gaps can be ensured in a very simple manner if natural changes in the sealing element geometry, such as the swelling of the sealing element in the medium, are compensated for by varying the volume flow supplied.

The invention also provide for an arrangement for sealing a gap between first and second parts of a hydraulic machine, wherein the first and second parts move with respect to each other. The arrangement comprises at least one sealing element mounted with respect to the first and second parts. A first hydrostatic bearing is formed between a first surface of the at least one sealing element and a surface of the first part. A second hydrostatic bearing is formed between a second surface of the at least one sealing element and a surface of the second part. At least one first bearing element is arranged on at least one of the surface of the first part and the first surface. At least one second bearing element is arranged on at least one of the surface of the first part and the first surface. At least one supply line is structured and arranged to supply a hydraulic bearing medium. The hydraulic bearing medium is fed via the at least one supply line to the at least one first bearing element, and thereafter, the hydraulic bearing medium is fed via hydraulic resistance from the at least one first bearing element to the at least one second bearing element.

The at least one second bearing element may be arranged on the same surface as the at least one first bearing element and is spaced from the at least one first bearing element by a distance. The at least one supply line may be aligned with the at least one first bearing element. The at least one supply line may be axially aligned with the at least one first bearing element. The at least one supply line may be radially aligned with the at least one first bearing element. The hydraulic resistance may be created in a bearing gap formed in first hydrostatic bearing by the surface of the first part and the first surface. The at least one first bearing element may comprise one of a groove and a flute. The at least one second bearing element may comprise one of a groove and a flute. Each of the at least one first bearing element and the least one second bearing element may comprise one of a groove and a flute. The at least one first bearing element may comprise one of a blind groove and a blind flute. The at least one second bearing element may be connected to the second hydrostatic bearing via a hydraulic connection. The at least one second bearing element may be in fluid communication with the second hydrostatic bearing via at least one passage formed in the at least one sealing element.

The at least one first bearing element of the first hydrostatic bearing may not be directly hydraulically connected to the second hydrostatic bearing. The at least one second bearing element of the first hydrostatic bearing may not be aligned with at least one opening of the at least one supply line. The at least one second bearing element of the first hydrostatic bearing may be spaced at a distance from an opening of the at least one supply line.

The arrangement may further comprise at least one third bearing element arranged on at least one of the surface of the second part and the second surface.

The at least one supply line is structured and arranged to supply the hydraulic bearing medium to each of the first and second hydrostatic bearings. The at least one supply line may be structured and arranged to supply the hydraulic bearing medium first to the first hydrostatic bearing and then to the second hydrostatic bearing. The at least one supply line may be structured and arranged to supply the hydraulic bearing medium to each of the first and second hydrostatic bearings, whereby the first hydrostatic bearing receives greater fluid pressure than the second hydrostatic bearing. The hydraulic bearing medium may be fed via the at least one supply line to the at least one first bearing element under a first pressure, and thereafter, the hydraulic bearing medium is fed via hydraulic resistance from the at least one first bearing element to the at least one second bearing element under a second pressure, whereby the first pressure is greater than the second pressure. The arrangement may further comprise at least one third bearing element arranged on at least one of the surface of the second part and the second surface, wherein the hydraulic bearing medium is fed through the at least one sealing element to the at least one third bearing element under a third pressure, whereby the third pressure is substantially the same as the second pressure.

The arrangement may further comprise at least one third bearing element arranged on at least one of the surface of the second part and the second surface, wherein the at least one second bearing element of the first hydrostatic bearing comprises a width that is less than a width of the at least one third bearing element of the second hydrostatic bearing.

The at least one sealing element may comprise a sealing ring. The at least one sealing element may be mounted in a floating manner via the first and second hydrostatic bearings. The at least one sealing element may move independently of the first and second parts. The at least one sealing element may rotate independently of the first and second parts. The first part may comprise an impeller of the hydraulic machine and the second part may comprise a housing of the hydraulic machine.

The hydraulic machine may comprise a turbo machine. The hydraulic machine may comprise a turbine. The turbine may comprise a Francis turbine. The turbine may comprise a pump turbine. The hydraulic machine may comprise a pump.

The at least one first bearing element may comprise an annular groove which is interrupted in sections over a circumference. The at least one second bearing element may comprise an annular groove which is interrupted in sections over a circumference. The at least one sealing element may comprise at least one connecting passage communicating with the first and second hydrostatic bearings. The first part may comprise a housing and the at least one supply line may be at least partly formed as a passage in the housing. The at least one sealing element may be structured and arranged to provide a predetermined bearing gap in each of the first and second hydrostatic bearings.

The arrangement may further comprise at least one third bearing element arranged on at least one of the surface of the first part and the first surface, wherein the at least one third bearing element is arranged on the same surface as the at least one first and second bearing elements, and wherein the at least one third bearing element is spaced from the at least one second bearing element by a first distance and from the at least one first bearing element by a second greater distance. The at least one first bearing element may be arranged between the at least one second and the at least one third bearing elements. The at least one first bearing element may comprise a greater width than the at least one second and the at least one third bearing elements.

The at least one first bearing element may be substantially centrally disposed. The at least one first bearing element may comprise a greater width than the at least one second bearing element.

The arrangement may further comprise at least one third bearing element arranged on at least one of the surface of the second part and the second surface, wherein a distance between outer edges of the at least one first bearing element and the at least one second bearing element is less than an overall width of the at least one third bearing element.

The at least one supply line may be structured and arranged to supply to each of the first and second hydrostatic bearings a substantially constant volume of the bearing medium. The at least one supply line may be connected to at least one pump. The at least one supply line may comprise a plurality of supply lines. The at least one supply line may comprise a plurality of supply passages. The at least one supply line may be connected to a portion of the hydraulic machine containing headwater.

The arrangement may further comprise at least one restrictor device arranged upstream of an opening of the at least one supply line. The restrictor device may comprise a flow regulating valve. The restrictor device may comprise a conduit and a flow regulating valve. The at least one sealing element may be structured and arranged to minimize a loss of power of the hydraulic machine. The at least one sealing element may be structured and arranged to minimize a loss of power of the hydraulic machine while maximizing sealing between the first and second parts.

The arrangement may further comprise at least one hydrodynamic bearing element arranged on at least one of the first surface of the at least one sealing element, the surface of the first part, the second surface of the at least one sealing element, and the surface of the second part.

The arrangement may further comprise at least one bearing pocket arranged on at least one of the first surface of the at least one sealing element, the surface of the first part, the second surface of the at least one sealing element, and the surface of the second part.

The at least one first bearing element may comprise a lubrication pocket.

The invention also provides for a method of sealing a gap between first and second parts of a hydraulic machine, wherein the method comprises arranging at least one sealing element adjacent the first and second parts, wherein a first hydrostatic bearing is formed between a first surface of the at least one sealing element and a surface of the first part and a second hydrostatic bearing is formed between a second surface of the at least one sealing element and a surface of the second part, supplying a hydraulic medium to at least the first hydrostatic bearing, and switching on the hydraulic machine, wherein the supplying increases a distance between the first surface the surface of the first part, and wherein the supplying occurs before the switching on.

The distance may comprise a predefined bearing gap. The method may further comprise substantially maintaining the predefined bearing gap. The method may further comprise ensuring that the bearing gap remains stable. The method may further comprise, when the hydraulic medium fails to flow, switching off the hydraulic machine. The method may further comprise, when the hydraulic medium fails to flow, supplying a hydraulic medium to at least the first hydrostatic bearing from an emergency supply source. The emergency supply source may comprise one of an air reservoir and an emergency supply reservoir.

The method may further comprise, after the switching on, substantially reducing to a minimum a flow of the hydraulic medium. The method may further comprise, after the switching on, switching off a number of supply sources providing the hydraulic medium. The method may further comprise varying a flow of the hydraulic medium in order to compensate for natural changes in a geometry of the at least one sealing element.

The natural changes may comprise a temperature influence, an effect of centrifugal force, and swelling of the at least one sealing element.

The method may further comprise varying a flow of the hydraulic medium in order to maintain substantially constant bearing gaps in each of the first and second hydrostatic bearings. The method may further comprise maintaining substantially constant bearing gaps in each of the first and second hydrostatic bearings.

The invention also provides for a method of sealing a gap between first and second parts of a hydraulic machine, wherein the method comprises arranging at least one sealing element adjacent the first and second parts, wherein a first hydrostatic bearing is formed between a first surface of the at least one sealing element and a surface of the first part and a second hydrostatic bearing is formed between a second surface of the at least one sealing element and a surface of the second part, supplying a substantially constant flow of hydraulic medium to at least the first hydrostatic bearing, switching on the hydraulic machine, and reducing, in a controlled manner, a flow of the hydraulic medium to at least the first hydrostatic bearing, wherein the supplying increases a distance between the first surface the surface of the first part, and wherein the switching on occurs after the supplying and before the reducing.

The reducing may produce a frictional engagement in the first hydrostatic bearing. The frictional engagement may produce a rubbing of surfaces. The frictional engagement may produce a bearing pattern. The frictional engagement may produce a grinding of surfaces. The method may further comprise, at least one of during and after the frictional engagement, increasing the flow of the hydraulic medium in order to produce predefined bearing gaps in each of the first and second hydrostatic bearings. The method may further comprise, at least one of during and after the frictional engagement, increasing the flow of the hydraulic medium in order to substantially maintain predefined bearing gaps in each of the first and second hydrostatic bearings.

The invention also provides for a method of designing a sealing element for sealing a gap between first and second parts of a hydraulic machine, wherein the method comprises determining a power loss and a geometry of the at least one sealing element while taking account of at least one of a predefined power loss, a geometry, and operating characteristics of the hydraulic machine.

The geometry of the at least one sealing element may comprise a width, a height, a position of at least one bearing element, a dimension of the at least one bearing element, at least one bearing surface, and at least one hydraulic connection. The geometry of the hydraulic machine may comprise at least one dimension of a supply line. The calculating may utilize at least one of a mathematical model and a physical model of the at least one sealing element. The method may further comprise optimizing the geometry of the at least one sealing element based on an energy consumption, wherein the power loss of the at least one sealing element is substantially minimized. The method may further comprise optimizing the geometry of the at least one sealing element and substantially minimizing the power loss of the at least one sealing element. The calculating may occur with a computer.

The invention also provides for an arrangement for sealing a gap between first and second parts of a hydraulic machine, wherein the first and second parts move with respect to each other, wherein the arrangement comprises at least one sealing ring mounted with respect to the first and second moving parts, a first hydrostatic bearing being formed between a first surface of the at least one sealing ring and a surface of the first part, a second hydrostatic bearing being formed between a second surface of the at least one sealing element and a surface of the second part, first and second spaced apart grooves arranged on the first surface, the first groove comprising a blind groove, and at least one supply line structured and arranged to supply a hydraulic bearing medium to the first groove.

The second groove may be in fluid communication with the second hydrostatic bearing via at least one passage formed in the at least one sealing element. The surface of the first part may comprise an opening which is aligned with the first groove and which communicates with the at least one supply line.

### BRIEF DESCRIPTION OF THE DRAWINGS

The present invention will be described in the following text by the exemplary, non-limiting embodiments shown in the figures, wherein:

FIG. 1 shows a cross section of a typical Francis turbine;

FIG. 2 shows a detail view of the sealing region between impeller and housing with a sealing element according to the invention;

FIG. 3 shows a further specific embodiment of a sealing element; and

FIG. 4 shows a graph representing geometric conditions of the sealing element.

### DETAILED DESCRIPTION OF THE PRESENT INVENTION

Before the actual description, some terms will be defined and explained in more detail in the following text.

Use is often made of the terms bearing elements, such as grooves, and bearing surface which, in the sense of this application, in each case describe a ring-like or cylindrical structure. In this case, a bearing element or bearing surface can have any desired widths and depths or heights and can be continuous in the circumferential direction or else interrupted in some sections at one or more points. A bearing element can of course have any desired cross-sectional shape, an example including a triangular flute, and does not necessarily have to be designed as a groove.

A hydraulic bearing always comprises mutually facing bearing surfaces, at least one bearing element, such as a groove, flutes or the like, being arranged in at least one of the bearing surfaces. If, then, a plurality of bearing elements is arranged over the circumference, because a bearing element is, for example, interrupted in sections as described above, it would also be necessary, in order to be consistent, to speak of a plurality of hydrostatic bearings which are arranged distributed over the circumference. For reasons of simplicity, however, even in such cases, only one hydrostatic bearing will ever be referred to in the application.

Hydraulic connection or connecting bore, in the sense of this application, designates at least one hollow space with at least two open ends, it being possible for a medium to flow through this hollow space on any desired path from one end to the other end.

If mention is made of a supply line, then it is to be noted that a number of such identical or similar supply lines, that is to say a series of supply lines, can be arranged in the circumferential direction. The same is also true, of course, of a connecting bore. In order not to permit the description to become too complicated, however, mention is normally made of only one supply line or one connecting bore, this naturally also comprising a series of supply lines or connecting bores, as appropriate.

For reasons of simplicity, the seal according to the invention will be described only by using a turbine, specifically a Francis turbine, but with it naturally being possible for this seal to be used in an equivalent manner in all other hydraulic machines with mutually mobile parts, such as an impeller which runs in a machine housing, such as in the case of pumps or pump turbines, as well.

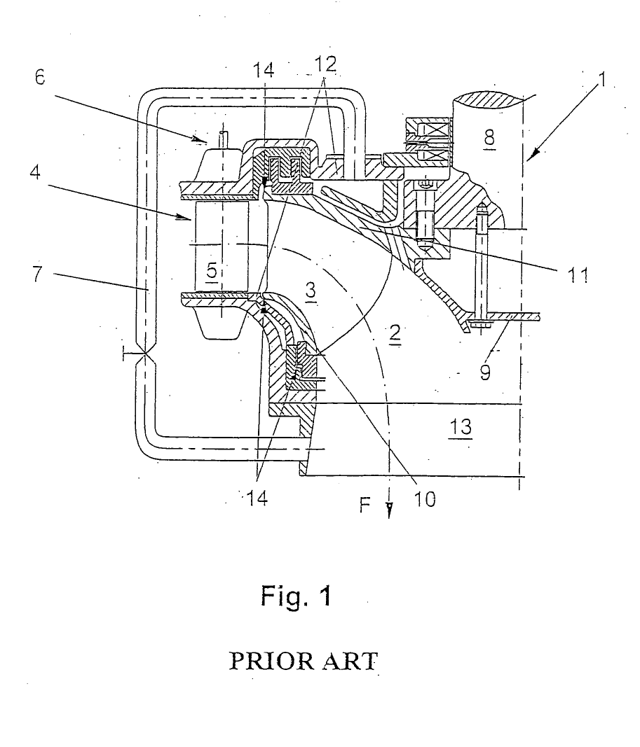

FIG. 1 then shows a turbine 1, here a Francis turbine, having an impeller 2 which runs in a turbine housing 12. The impeller 2 has a number of turbine blades 3 which are delimited by an inner 11 and outer cover disk 10. The impeller 2 is fixed to one end of the shaft 8 such that it is secure against rotation with respect to the shaft 8 by way of a hub cover 9 and possibly by way of still further fastening devices, such as bolts or screws. The shaft 8 is rotatably mounted by way of shaft bearings, not illustrated, and, in a known way, drives, for example, a generator, likewise not illustrated, for the production of electrical power, which is preferably arranged on the other end of the shaft 8.

The inflow of the liquid medium, normally water, from a headwater, such as a water reservoir located higher up, is carried out in most cases via a spiral housing which is not illustrated here but sufficiently well known. Between the spiral housing and impeller 2 there is a guide apparatus 4, comprising a number of guide vanes 5, which in this example, can be rotated by way of an adjusting apparatus 6. The adjustable guide vanes 5 are used to regulate the output of the turbine 1 by changing both the volume flow through the turbines 1 and also the impeller entry pitch. In addition, supporting vanes could also be arranged in a known manner between the spiral housing and guide vanes 5.

The discharge of the water is carried out, as shown in FIG. 1, via a suction pipe 13 immediately following the turbine 1 and opening into a tail water, not illustrated. The result of this is a main water stream F, identified by the arrow, from the spiral housing via the guide apparatus 4 and the impeller 2 to the suction pipe 13.

In addition to the main water stream F, in the case of conventional seals 14, a gap water stream is also formed through the impeller lateral spaces between turbine housing 12 and outer 10 and inner cover disk 11. The gap water of the radial impeller lateral space is, for example, discharged via a restrictor by way of a line 7 and led into the suction pipe 13. In addition, as indicated in FIG. 1, relief bores are often provided in the inner cover disk, via which the radial impeller lateral space is connected to the main water stream F. By way of the seal according to the invention, as described further below, these gap water streams are now suppressed, so that the entire water flowing in flows through the impeller 2 and its flow energy can be utilized completely without gap losses. Furthermore, the friction in the impeller lateral space is reduced or even minimized since, with such a seal, no rotating disk of water is formed in the impeller lateral space any more; instead, this space, with the exception of the bearing water, is filled with air. Furthermore, the axial thrust acting on the shaft 8 and on the shaft mounting is reduced sharply as a result.

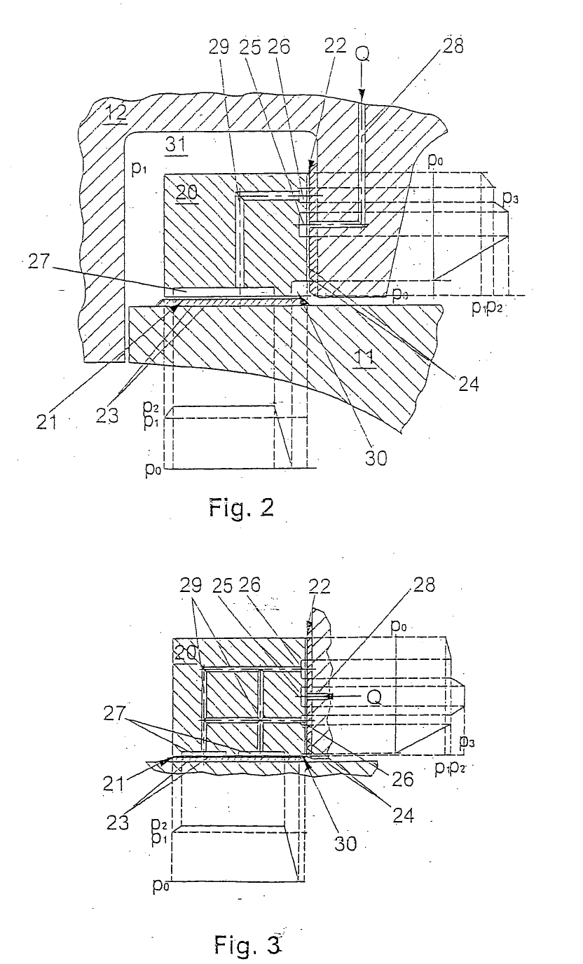

FIG. 2 now shows a detailed view of an exemplary inventive seal of an impeller 2 of a turbine 1 between turbine housing 12 and inner cover disk 11, by way of a sealing element 20 designed as a sealing ring. In this case, the turbine housing 12 has a shoulder on which a radial bearing surface 24 is arranged. Likewise, an axial bearing surface 23 is arranged on the inner cover disk 11. These bearing surfaces 23, 24 can be separate components which are subsequently applied at the necessary point, for example, by way of welding, screwing, etc., or can of course also be machined in the corresponding component, for example, a surface-ground section on the inner cover disk 11.

The orientations “axial” and “radial” in this case refer to the directions of action of the hydrostatic bearings and are mainly introduced to make it easier to distinguish the two hydrostatic bearings 21, 22.

The radial 24 and the axial bearing surface 23 on the turbine housing 12 and on the inner cover disk 11 is in each case assigned a radial 24 and axial bearing surface 23 on the sealing ring 20, which in each case form part of a hydrostatic bearing 21, 22 in the axial and radial direction.

In the design according to FIG. 2, a bearing medium, such as water, is fed into the radial hydrostatic bearing 22 via the turbine housing 12 by way of a supply line 28. Here, the supply line 28 is formed of bores, and is connected via further lines, indirectly or directly, to a supply source, not illustrated, such as a pump and/or the headwater, possibly via auxiliary devices such as filters, cyclones, etc. Of course, a plurality of supply lines 28 can be distributed over the circumference, it being possible for an arrangement beneficial to an adequate supply, for example, three supply lines 28 which are in each case arranged offset by an angle of 120°, to be provided. Of course, any other arrangement is also conceivable.

The radial bearing 22 now has two bearing elements in the form of grooves 25, 26, one groove 25 being arranged in the sealing ring 20 in the region of the opening of the supply line 28, and the second groove 26 likewise being arranged in the sealing ring 20 at a distance from the first groove 25. This second groove 26 is then connected via one or more connecting bore(s) 29 to a groove 27 arranged in the sealing ring 20 and belonging to the axial bearing 21. The two grooves 25, 26 of the radial bearing 22 are now arranged in such a way that the supply line 28 opens neither wholly nor partially into the second groove 26 in all the operating positions of the sealing ring 20.

It should also be noted, in particular, that the bearing elements, here grooves 25, 26 and 27, could also equally be arranged in the axial or radial bearing surface 23, 24 of the turbine housing 12 or of the impeller 2, as well as here, in the inner cover disk 11. It would likewise be possible to provide bearing elements both in the sealing element 20 and in the turbine housing 12 or at any desired point on the impeller 2.

Thus, both hydrostatic bearings 21, 22 are supplied with bearing medium from a single supply line 28 or series of supply lines 28. The bearing medium is, in this case, fed into the radial bearing 22 and flows via the connecting bores 29 into the axial bearing 21. In order to ensure an adequate supply of the axial bearing 21, a plurality of connecting bores 29 are advantageously provided over the circumference of the sealing ring 20, for example, a bore every 3 to 8 centimeters, depending on the circumference. The groove 27 of the axial bearing 21 could equally well also be designed in such a way that, in the region of the outer and inner diameter of the sealing ring 20, in each case a narrower groove is arranged, is in each case connected to the radial bearing 22 and is supplied via a connecting bore 29.

Of course, the supply line 28 could also open in the axial bearing 21; the arrangement of the grooves 25, 26 and 27 on the diagonals of the sealing ring would then also be mirrored appropriately.

In order to be able to describe the function of the sealing ring 20, the pressure distributions which result in the axial and radial bearings 21, 22 are additionally also illustrated in FIG. 2. The bearing medium, as described above, is fed into the axial bearing 21 via the supply line 28 with a constant volume flow Q. The volume flow Q of the bearing medium is divided in the radial bearing 22 into two streams. One stream flows downward and ultimately opens into the axial impeller lateral space with the pressure p₀. The greater part of the volume flow Q flows upward to the second groove 26 and flows via the connecting bore 29 into the radial bearing 21 and opens partially into the bearing space 31 with the pressure p₁ prevailing at the impeller entry.

The volume flow Q causes the pressure distribution illustrated with a maximum pressure p₃ in the groove 25 into which the supply line 28 opens, which lifts the sealing ring 20 in the radial direction. In this connection, radial lifting of course means that the bearing gap between surfaces 24 of the housing 12 and the sealing ring 20 widens. This widening is counteracted both by the headwater pressure p₁ and also, in accordance with the theory of elasticity, by the elastic restoring forces. The maximum pressure p₃ must therefore be sufficiently high to be able to effect such widening of the bearing gap as is desired. This widening or bearing gap can be, for example, typically between approximately 50 μm and approximately 100 μm. In the second groove 26, because of the geometry, a lower pressure P₂ is built up, which at the same time also acts in the groove 27 of the axial bearing 21 through the connecting bore 29. This pressure P₂ must be sufficiently high to cause the sealing ring 20 to lift in the axial direction, which can be achieved by the two grooves 25, 26 of the radial bearing 22 being arranged very highly asymmetrically and very close together, as illustrated in FIG. 2.

If the grooves 25, 26 were too far apart, then the pressure drop between the grooves 25, 26 would be too high and the requisite lifting pressure P₂ would not be reached. This means that the pressure P₂, for the example according to FIG. 2, is defined by the geometry of the axial bearing of the sealing ring 20, that is to say substantially the width and position of the grooves of the corresponding bearing 22, external dimensions of the sealing ring 20, and possibly the recesses 30. Then, if the volume flow Q were to be increased further, the pressure P₂ would nevertheless remain substantially the same and the sealing ring 20 would merely lift further in the axial direction.

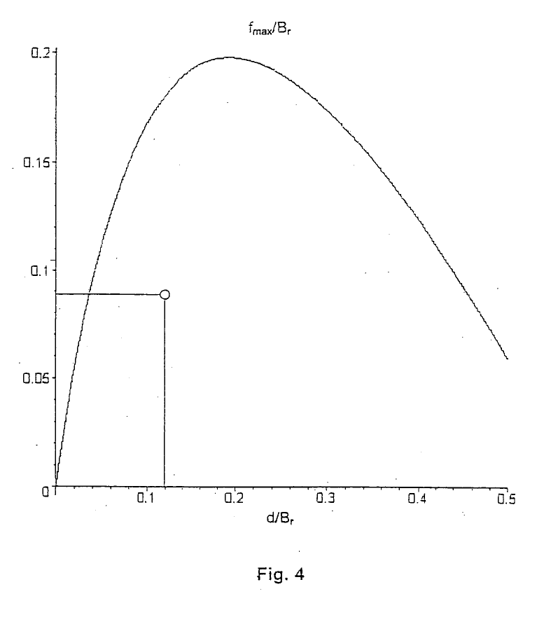

By applying fundamental hydraulic laws for a specific geometry of the sealing ring 20 and any desired arrangement of the grooves 25, 26, 27, a maximum distance fₘₐₓ between the two grooves 25, 26 may be defined, which depends only on the geometry and which must be maintained in order to cause the sealing ring 20 to be lifted in both directions. The determination of the maximum distance fₘₐₓ represents a standard task to an appropriate person skilled in the art. FIG. 4 (which here relates to the geometry of FIG. 2) illustrates a curve determined for such a maximum distance fₘₐₓ. In this example, the external dimensions of the sealing ring 20 and the geometric dimensions of the axial hydrostatic bearing 21 and certain geometric dimensions of the radial hydrostatic bearing 22 are kept constant, and only the distance “d” of the upper edge of the sealing ring 20 from the second groove 26 is varied, and the result is represented in the form of a graph in FIG. 4. The variables used in the graph were in this case referred to the width Br of the radial bearing 21 and therefore made dimensionless. Here, the point drawn in FIG. 4 shows the distance “f” according to the geometry of FIG. 2. It can clearly be seen that the sealing ring 20 is in the stable range.

If other geometric parameters are varied, then, of course, under certain circumstances other forms of the curve or area are obtained, for example, given the variation of two parameters. Identical relationships can of course also be specified for other configurations of a sealing ring 20, for example as described in FIG. 3.

The sealing ring 20 therefore then floats in a stable manner on two sliding films virtually without friction, and is therefore “floatingly” supported. During operation, because of the free mounting, the sealing ring 20 will co-rotate at approximately half the circumferential speed of the impeller 2, since it is not held secured against rotation. As a result, a gain in dynamic stability results, since in this way the limiting circumferential speed or the fluttering limit is raised. Furthermore, the friction losses also become lower.

As a result of the high stability of a hydrostatic bearing, the sealing ring 20 is able to compensate for vibrations of the impeller 2 and/or of the turbine housing 12 and also axial displacement of the impeller 2 without losing the sealing effect and without coming into contact with the impeller 2 and/or the turbine housing 12. The sealing ring 20 suffers virtually no wear as a result, which means that the service life of such a sealing ring 20 is very long. The fact that the sealing ring 20 can be constructed as a very slim, lightweight ring which has barely any inertial forces also reinforces this action.

The sealing ring 20 can be constructed to be very small in relation to the dimensions of the turbine 1; edge lengths of a few centimeters, for example 5 cm or 8 cm, are completely adequate, given external diameters of a few meters, and it can be fabricated from any desired material, such as steel, bearing bronze, plastic (e.g. PE). Furthermore, the bearing surfaces 23, 24 could also be covered with a suitable layer, such as Teflon, bearing bronze, etc., in order to improve the properties of the seal still further. Typically, the sealing ring 20 is produced from a softer material than the housing 12 or the impeller 2 of the hydraulic machine. As a result, firstly it is normally lighter and, secondly, in the extreme case, it is the sealing ring 20 and not the impeller 2 or the housing 12 which is damaged or even destroyed.

Since the sealing ring 20 can be constructed to be very small in cross section but very high pressures can act, there is the risk of the sealing ring 20 rolling up. In order to be able to compensate for the rolling moments which arise, the sealing ring 20 should be designed to be free of moments, that is to say the sealing ring 20 should exhibit no resultant moments during operation. As can easily be considered, this can be achieved by the sealing ring 20 being designed in such a way that the resulting forces of the respective pressure distributions on the sides of the sealing ring 20, that is to say the resulting forces of the headwater pressure p₁ and the pressure distributions which arise in the hydrostatic bearings 21, 22 lie on one line of action. In order to achieve this, in addition to the overall geometry of the sealing ring 20, such as the dimensions of the grooves 25, 26, 27, the bearing gap widths, the external dimensions, etc., use is also made, inter alia, of the recess 30.

The sealing ring 20 can, of course, have any desired cross section, such as an L-shaped cross section. However, a square or rectangular shape is preferred from a fabrication point of view.

FIG. 3 shows a further exemplary embodiment of an inventive sealing ring 20. This sealing ring 20 now has three grooves 25, 26 in the radial bearing 22, a supply line 28, via which a volume flow Q of a bearing medium is supplied, opening in the region of the central groove 25, as described in FIG. 2. The two grooves 26 arranged at the side of this central groove 25 are in each case connected via connecting bores 29 to the two grooves 27 of the axial hydrostatic bearing 23. In this example, two grooves 27 are provided, which develops the same action as a continuous groove 27, as described in FIG. 2. Therefore, the distance between the external diameter of the left-hand and the internal diameter of the right-hand groove 27 can be viewed as the width of the groove of the axial hydrostatic bearing 23.

Each of the two outer grooves 26 of the radial bearing 22 is here connected to each of the grooves 27 of the axial bearing 23 via a system of connecting bores 29 which are arranged in a cross-sectional plane of the sealing ring 20. However, it is also conceivable to separate the connections and to arrange them in different cross-sectional planes of the sealing ring 20. In one cross-sectional plane, for example, the upper groove 26 would be connected to the right-hand groove 27, in a next cross-sectional plane the lower groove 26 would be connected to the left-hand groove 27 and in a next, again, in turn a system of connecting bores 29 could be arranged, as shown in FIG. 3. In this case, any desired combination is of course possible as required.

If the pressure distributions of this sealing ring 20 are considered, then it can be seen that the pressure distribution, as compared with the configuration according to FIG. 2, remains essentially unchanged in the axial hydrostatic bearing 21 within the context of the geometric relationships, while the pressure distribution in the radial hydrostatic bearing 22 changes considerably. This pressure distribution, effected by the third groove 26, is now broader and has lower pressure peaks, which means that such a sealing ring 20 can be operated with a lower supply pressure.

The three grooves 25, 26 of the radial hydrostatic bearing can of course be arranged substantially as desired. For example, the two outer grooves 26 could have the same width and be arranged symmetrically around the central groove 25 or with respect to the sealing ring 20 itself. Otherwise, the arrangement of the three grooves 25, 26 could also be made completely asymmetrically.

Likewise, it would be conceivable to provide more than three grooves, as a result of which a still flatter pressure distribution could be achieved under certain circumstances.

In the examples according to FIGS. 2 and 3, the supply line 28 always opens into the radial hydrostatic bearing 22, whereas the axial hydrostatic bearing 21 is supplied through connecting bores 29. If necessary, this arrangement can of course also be designed conversely.

In addition, until this point, flat bearing surfaces 23, 24 have always been assumed. Of course, however, it is also conceivable to design the bearing surfaces 23, 24 not to be flat, for example ground concavely or stepped, nothing changing in the fundamental principle of the seal according to the invention. In the case of such non-flat bearing surfaces 23, 24, only the pressure distributions would change somewhat, but this can clearly be seen by an appropriate person skilled in the art.

As a result of the operation of the sealing ring 20, a certain power loss arises, for example, as a result of the necessary power of one or more supply pump(s), as a result of hydraulic friction in the bearing gap, as a result of tailwater losses, that is to say bearing medium which cannot be led through the impeller 2, etc., which should be kept as low as possible. Part of this power loss can of course be recovered by part of the bearing medium being led into the main water stream F and converted into power in the impeller 2. Nevertheless, it is desirable to minimize the power loss of the sealing ring 20. For this purpose, the geometry of the sealing ring 20, that is to say width, height, position and dimensions of the grooves 25, 26, 27 and bearing surfaces 23, 24, dimensions and position of the supply lines 28 and of the connecting bores 29, etc., are adapted in order to minimize the power loss produced. This can be carried out, for example, by way of suitable mathematical, for example numerical, calculations using mathematical, physical models of the sealing ring, in which an appropriately formulated optimization problem is solved. Using conventional computers and appropriate software, such an optimization problem can be solved. It is of course also possible for the geometry and/or the operating characteristics, for example design points, powers, and pressures, etc., of the hydraulic machine to be included in these calculations.

In order to improve the bearing action and the stability, one or more of the bearing surfaces 23, 24 could also be provided with sufficiently well known hydrodynamic lubrication pockets.

In principle, a number of supply lines 28 will be led together to a large collecting line, which is then supplied with bearing medium by a bearing medium source, such as a pump. The number of bearing medium sources and collecting lines can of course be selected freely as required here.

A seal according to the invention having a sealing ring 20 can of course be provided at any suitable point and is not restricted to the exemplary embodiments according to FIGS. 2 and 3. For instance, the sealing ring 20 could also be arranged between the front side of the impeller 2 or inner cover disk 11 and the turbine housing 12. It is equally conceivable to provide such a seal at a suitable point between the outer cover disk 10 and the machine housing 12.

In addition, the arrangement of the grooves 25, 26, 27 and the connecting bores 29 and supply line 28 in FIGS. 2 and 3 is merely exemplary. Instead, this arrangement can be selected as desired within the scope of the invention. For instance, the groove 26 which is connected via the connecting bore 29 to the groove 27 of the other hydrostatic bearing 21 could equally well also be arranged in the vicinity of the recess 30, that is to say underneath the groove 25 in FIG. 2. The entire arrangement could likewise be mirrored on the diagonals of the sealing ring. All possible and conceivable variants are of course covered by this application.

The above described seal constitutes a largely tight seal. The entire amount of water flowing in flows through the impeller and can be converted into rotational energy. The gap water losses are in this case reduced exclusively to the bearing medium which emerges, are therefore very small and can partly be recovered again by leading the gap water into the main water stream F.

In all phases of the operation, if possible the situation should be avoided in which the sealing ring 20 comes into contact with the bearing surfaces 23, 24 or mixed friction states are established in the hydraulic bearings 21, 22, since then the sealing ring 20 can very easily be damaged or even destroyed. When the turbine 1 is started, the sealing ring 20 should therefore already have been lifted, that is to say the desired bearing gaps should already be reached. This can be achieved simply by the supply of the hydraulic bearings 21, 22 being turned on first and only then the turbine 1 being switched on.

In the event of failure of the supply of the hydrostatic bearings 21, 22, it would be possible, for example, to provide an emergency supply, such as an air reservoir, in order to avoid damage to the sealing ring 20 of the hydraulic machine, which would entail complicated maintenance work.

During the first commissioning of the sealing ring 20, however, it may be desirable to establish a controlled mixed friction state in the hydraulic bearings 21, 22, so that a bearing pattern can be ground into the bearing surfaces 23, 24, by which arrangements certain fabrication inaccuracies can be compensated for. Since the bearing gaps lie in the hundred μm range or below, appropriate care is of course taken.

In the description above, for reasons of simplicity, water is described as the bearing medium. Of course, above all in the case of pumps, the bearing medium can also be any other desired suitable medium, such as an oil.

For the purpose of clarity, in the entire application, grooves, flutes or the like are always mentioned as bearing elements. However, it is entirely conceivable not to define one or more bearing elements clearly in this way. Any gap flow, even between groove-free smooth surfaces, naturally has a certain hydraulic resistance, so that a hydrostatic bearing would even function without defined bearing elements, for example, only with flat surfaces. Furthermore, the result of surface roughness would be a further influence on the hydraulic resistance; for example the bearing surfaces 23, 24 could be ground differently in order to form “bearing elements”.

By way of non-limiting example, the sealing ring shown in FIGS. 2 and 3 can have a cross-sectional shape and size which is in the range of between approximately 30×30 mm and approximately 100×100 mm. Of course, the sealing ring can have any cross-sectional shape other than a square cross-sectional shape. One or more of the grooves of the sealing ring can have a depth which is in the range of between approximately 5% and approximately 10% of the width of the sealing ring. One or more of the grooves of the sealing ring can also have a width which is in the range of between approximately 10% and approximately 90% of the width of the sealing ring. The diameter of the connecting bores in the sealing ring can be sized as large as necessary/possible in order to minimize friction losses and/or increase fluid flow. Of course, the particular dimensions of the sealing ring can be adjusted for each application for optimum operation/performance of the sealing ring. One can calculate the dimensions of the sealing ring by applying basic principles of fluid mechanics and performing calculations on a standard personal computer. Thus, for example, in an application wherein the sealing ring is arranged at an outlet of a turbine with a runner diameter at the outlet of 640 mm, the sealing ring can have the general configuration shown in FIG. 2 and can be approximately 40×40 mm in cross-section. The sealing ring can utilize three grooves with widths of approximately 7 mm, 5 mm, and 20 mm. Each groove can have a depth of approximately 3 mm. The sealing ring can further utilize 60 connecting bores which have a diameter of approximately 5 mm.

1. An arrangement for sealing a gap between first and second parts of a hydraulic machine, wherein the first and second parts move with respect to each other, the arrangement comprising:
at least one sealing element mounted with respect to the first and second parts;
a first hydrostatic bearing being formed between a first surface of the at least one sealing element and a surface of the first part;
a second hydrostatic bearing being formed between a second surface of the at least one sealing element and a surface of the second part;
at least one first bearing element arranged on at least one of the surface of the first part and the first surface;
at least one second bearing element arranged on at least one of the surface of the first part and the first surface; and
at least one supply line structured and arranged to supply a hydraulic bearing medium,
wherein the hydraulic bearing medium is fed via the at least one supply line to the at least one first bearing element, and thereafter, the hydraulic bearing medium is fed via hydraulic resistance from the at least one first bearing element to the at least one second bearing element.

2. The arrangement of claim 1, wherein the at least one supply line is substantially aligned with the at least one first bearing element.

3. The arrangement of claim 1, wherein the at least one supply line is substantially axially aligned with the at least one first bearing element.

4. The arrangement of claim 1, wherein the at least one supply line is substantially radially aligned with the at least one first bearing element.

5. The arrangement of claim 1, wherein the hydraulic resistance is created in a bearing gap formed in first hydrostatic bearing by the surface of the first part and the first surface.

6. The arrangement of claim 1, wherein the at least one first bearing element comprises one of a groove and a flute.

7. The arrangement of claim 1, wherein the at least one second bearing element comprises one of a groove and a flute.

8. The arrangement of claim 1, wherein each of the at least one first bearing element and the least one second bearing element comprises one of a groove and a flute.

9. The arrangement of claim 1, wherein the at least one first bearing element comprises one of a blind groove and a blind flute.

10. The arrangement of claim 1, wherein the at least one second bearing element is connected to the second hydrostatic bearing via a hydraulic connection.

11. The arrangement of claim 1, wherein the at least one second bearing element is in fluid communication with the second hydrostatic bearing via at least one passage formed in the at least one sealing element.

12. The arrangement of claim 1, wherein the at least one first bearing element of the first hydrostatic bearing is not directly hydraulically connected to the second hydrostatic bearing.

13. The arrangement of claim 1, wherein the at least one second bearing element of the first hydrostatic bearing is not aligned with at least one opening of the at least one supply line.

14. The arrangement of claim 1, wherein the at least one second bearing element of the first hydrostatic bearing is spaced at a distance from an opening of the at least one supply line.

15. The arrangement of claim 1, further comprising at least one third bearing element arranged on at least one of the surface of the second part and the second surface.

16. The arrangement of claim 1, wherein the at least one supply line is structured and arranged to supply the hydraulic bearing medium to each of the first and second hydrostatic bearings.

17. The arrangement of claim 1, wherein the at least one supply line is structured and arranged to supply the hydraulic bearing medium first to the first hydrostatic bearing and then to the second hydrostatic bearing.

18. The arrangement of claim 1, wherein the at least one supply line is structured and arranged to supply the hydraulic bearing medium to each of the first and second hydrostatic bearings, whereby the first hydrostatic bearing receives greater fluid pressure than the second hydrostatic bearing.

19. The arrangement of claim 1, wherein the hydraulic bearing medium is fed via the at least one supply line to the at least one first bearing element under a first pressure, and thereafter, the hydraulic bearing medium is fed via hydraulic resistance from the at least one first bearing element to the at least one second bearing element under a second pressure, whereby the first pressure is greater than the second pressure.

20. The arrangement of claim 19, further comprising at least one third bearing element arranged on at least one of the surface of the second part and the second surface, wherein the hydraulic bearing medium is fed through the at least one sealing element to the at least one third bearing element under a third pressure, whereby the third pressure is substantially the same as the second pressure.

21. The arrangement of claim 1, further comprising at least one third bearing element arranged on at least one of the surface of the second part and the second surface, wherein the at least one second bearing element of the first hydrostatic bearing comprises a width that is less than a width of the at least one third bearing element of the second hydrostatic bearing.

22. The arrangement of claim 1, wherein the at least one sealing element comprises a sealing ring.

23. The arrangement of claim 1, wherein the at least one sealing element is mounted in a floating manner via the first and second hydrostatic bearings.

24. The arrangement of claim 1, wherein the at least one sealing element moves independently of the first and second parts.

25. The arrangement of claim 1, wherein the at least one sealing element rotates independently of the first and second parts.

26. The arrangement of claim 1, wherein the first part comprises an impeller of the hydraulic machine and the second part comprises a housing of the hydraulic machine.

27. The arrangement of claim 26, wherein the hydraulic machine comprises a turbo machine.

28. The arrangement of claim 26, wherein the hydraulic machine comprises a turbine.

29. The arrangement of claim 28, wherein the turbine comprises a Francis turbine.

30. The arrangement of claim 28, wherein the turbine comprises a pump turbine.

31. The arrangement of claim 1, wherein the hydraulic machine comprises a pump.

32. The arrangement of claim 1, wherein the at least one first bearing element comprises an annular groove which is interrupted in sections over a circumference.

33. The arrangement of claim 1, wherein the at least one second bearing element comprises an annular groove which is interrupted in sections over a circumference.

34. The arrangement of claim 1, wherein the at least one sealing element comprises at least one connecting passage communicating with the first and second hydrostatic bearings.

35. The arrangement of claim 1, wherein the first part comprises a housing and wherein the at least one supply line is at least partly formed as a passage in the housing.

36. The arrangement of claim 1, wherein the at least one sealing element is structured and arranged to provide a predetermined bearing gap in each of the first and second hydrostatic bearings.

37. The arrangement of claim 1, further comprising at least one third bearing element arranged on at least one of the surface of the first part and the first surface, wherein the at least one third bearing element is spaced from the at least one second bearing element by a first distance and from the at least one first bearing element by a second greater distance.

38. The arrangement of claim 37, wherein the at least one third bearing element is arranged on the same surface as the at least one first and second bearing elements.

39. The arrangement of claim 37, wherein the at least one first bearing element is arranged between the at least one second and the at least one third bearing elements.

40. The arrangement of claim 39, wherein the at least one first bearing element comprises a greater width than the at least one second and the at least one third bearing elements.

41. The arrangement of claim 1, wherein the at least one first bearing element is substantially centrally disposed.

42. The arrangement of claim 1, wherein the at least one first bearing element comprises a greater width than the at least one second bearing element.

43. The arrangement of claim 1, further comprising at least one third bearing element arranged on at least one of the surface of the second part and the second surface, wherein a distance between outer edges of the at least one first bearing element and the at least one second bearing element is less than an overall width of the at least one third bearing element.

44. The arrangement of claim 1, wherein the at least one supply line is structured and arranged to supply to each of the first and second hydrostatic bearings a substantially constant volume of the bearing medium.

45. The arrangement of claim 1, wherein the at least one supply line is connected to at least one pump.

46. The arrangement of claim 1, wherein the at least one supply line comprises a plurality of supply lines.

47. The arrangement of claim 1, wherein the at least one supply line comprises a plurality of supply passages.

48. The arrangement of claim 1, wherein the at least one supply line is connected to a portion of the hydraulic machine containing headwater.

49. The arrangement of claim 1, further comprising at least one restrictor device arranged upstream of an opening of the at least one supply line.

50. The arrangement of claim 49, wherein the restrictor device comprises a flow regulating valve.

51. The arrangement of claim 49, wherein the restrictor device comprises a conduit and a flow regulating valve.

52. The arrangement of claim 1, wherein the at least one sealing element is structured and arranged to minimize a loss of power of the hydraulic machine.

53. The arrangement of claim 1, wherein the at least one sealing element is structured and arranged to minimize a loss of power of the hydraulic machine while maximizing sealing between the first and second parts.

54. The arrangement of claim 1, further comprising at least one hydrodynamic bearing element arranged on at least one of the first surface of the at least one sealing element, the surface of the first part, the second surface of the at least one sealing element, and the surface of the second part.

55. The arrangement of claim 1, further comprising at least one bearing pocket arranged on at least one of the first surface of the at least one sealing element, the surface of the first part, the second surface of the at least one sealing element, and the surface of the second part.

56. The arrangement of claim 1, wherein the at least one first bearing element comprises a lubrication pocket.

57. The arrangement of claim 1, wherein the at least one second bearing element is arranged on the same surface as the at least one first bearing element and being spaced from the at least one first bearing element by a distance.

58. A method of sealing a gap between first and second parts of a hydraulic machine, the method comprising:
arranging at least one sealing element adjacent the first and second parts, wherein a first hydrostatic bearing is formed between a first surface of the at least one sealing element and a surface of the first part and a second hydrostatic bearing is formed between a second surface of the at least one sealing element and a surface of the second part;
supplying a hydraulic medium to at least the first hydrostatic bearing; and
switching on the hydraulic machine,
wherein the supplying increases a distance between the first surface the surface of the first part, and
wherein the supplying occurs before the switching on.

59. The method of claim 58, wherein the distance comprises a predefined bearing gap.

60. The method of claim 59, further comprising substantially maintaining the predefined bearing gap.

61. The method of claim 59, further comprising ensuring that the bearing gap remains stable.

62. The method of claim 58, further comprising, when the hydraulic medium fails to flow, switching off the hydraulic machine.

63. The method of claim 58, further comprising, when the hydraulic medium fails to flow, supplying a hydraulic medium to at least the first hydrostatic bearing from an emergency supply source.

64. The method of claim 63, wherein the emergency supply source comprises one of an air reservoir and an emergency supply reservoir.

65. The method of claim 58, further comprising, when the hydraulic medium fails to flow, supplying, at least over a certain time period, a hydraulic medium to at least the first hydrostatic bearing from an emergency supply source.

66. The method of claim 58, further comprising, after the switching on, substantially reducing to a minimum a flow of the hydraulic medium.

67. The method of claim 58, further comprising, after the switching on, switching off a number of supply sources providing the hydraulic medium.

68. The method of claim 58, further comprising varying a flow of the hydraulic medium in order to compensate for natural changes in a geometry of the at least one sealing element.

69. The method of claim 68, wherein the natural changes comprise a temperature influence, an effect of centrifugal force, and swelling of the at least one sealing element.

70. The method of claim 58, further comprising varying a flow of the hydraulic medium in order to maintain substantially constant bearing gaps in each of the first and second hydrostatic bearings.

71. The method of claim 58, further comprising maintaining substantially constant bearing gaps in each of the first and second hydrostatic bearings.

72. A method of sealing a gap between first and second parts of a hydraulic machine, the method comprising:
arranging at least one sealing element adjacent the first and second parts, wherein a first hydrostatic bearing is formed between a first surface of the at least one sealing element and a surface of the first part and a second hydrostatic bearing is formed between a second surface of the at least one sealing element and a surface of the second part;
supplying a substantially constant flow of hydraulic medium to at least the first hydrostatic bearing;
switching on the hydraulic machine;
reducing, in a controlled manner, a flow of the hydraulic medium to at least the first hydrostatic bearing,
wherein the supplying increases a distance between the first surface the surface of the first part, and
wherein the switching on occurs after the supplying and before the reducing.

73. The method of claim 72, wherein the reducing produces a frictional engagement in the first hydrostatic bearing.

74. The method of claim 73, wherein the frictional engagement produces a rubbing of surfaces.

75. The method of claim 73, wherein the frictional engagement produces a bearing pattern.

76. The method of claim 73, wherein the frictional engagement produces a grinding of surfaces.

77. The method of claim 73, further comprising, at least one of during and after the frictional engagement, increasing the flow of the hydraulic medium in order to produce predefined bearing gaps in each of the first and second hydrostatic bearings.

78. The method of claim 73, further comprising, at least one of during and after the frictional engagement, increasing the flow of the hydraulic medium in order to substantially maintain predefined bearing gaps in each of the first and second hydrostatic bearings.

79. A method of designing a sealing element for sealing a gap between first and second parts of a hydraulic machine, the method comprising:
determining a power loss and a geometry of the at least one sealing element while taking account of at least one of a predefined power loss, a geometry, and operating characteristics of the hydraulic machine.

80. The method of claim 79, wherein the geometry of the at least one sealing element comprises a width, a height, a position of at least one bearing element, a dimension of the at least one bearing element, at least one bearing surface, and at least one hydraulic connection.

81. The method of claim 79, wherein the geometry of the hydraulic machine comprises at least one dimension of a supply line.

82. The method of claim 79, wherein the calculating utilizes at least one of a mathematical model and a physical model of the at least one sealing element.

83. The method of claim 79, further comprising optimizing the geometry of the at least one sealing element based on an energy consumption, wherein the power loss of the at least one sealing element is substantially minimized.

84. The method of claim 79, further comprising optimizing the geometry of the at least one sealing element and substantially minimizing the power loss of the at least one sealing element.

85. The method of claim 79, wherein the calculating occurs with a computer.

86. An arrangement for sealing a gap between first and second parts of a hydraulic machine, wherein the first and second parts move with respect to each other, the arrangement comprising:
at least one sealing ring mounted with respect to the first and second moving parts;
a first hydrostatic bearing being formed between a first surface of the at least one sealing ring and a surface of the first part;
a second hydrostatic bearing being formed between a second surface of the at least one sealing element and a surface of the second part;
first and second spaced apart grooves arranged on the first surface;
the first groove comprising a blind groove; and
at least one supply line structured and arranged to supply a hydraulic bearing medium to the first groove,
wherein the hydraulic bearing medium is fed via the at least one supply line to the groove, and thereafter, the hydraulic bearing medium is fed via hydraulic resistance from the first groove to the second groove.

87. The arrangement of claim 86, wherein the second groove is in fluid communication with the second hydrostatic bearing via at least one passage formed in the at least one sealing element.

88. The arrangement of claim 86, wherein the surface of the first part comprises an opening which is aligned with the first groove and which communicates with the at least one supply line.
